(19) United States
(12) Patent Application Publication
(10) Pub. No.: US 2025/0024242 A1
(43) Pub. Date: Jan. 16, 2025

(54) SERVICE PROCESSING METHOD AND APPARATUS, TERMINAL, NETWORK SIDE DEVICE, AND READABLE STORAGE MEDIUM

(71) Applicant: VIVO MOBILE COMMUNICATION CO., LTD., Dongguan (CN)

(72) Inventors: Wen WANG, Dongguan (CN); Zhenhua XIE, Dongguan (CN)

(73) Assignee: VIVO MOBILE COMMUNICATION CO., LTD., Dongguan (CN)

(21) Appl. No.: 18/896,833

(22) Filed: Sep. 25, 2024

Related U.S. Application Data
(63) Continuation of application No. PCT/CN2023/084053, filed on Mar. 27, 2023.

(30) Foreign Application Priority Data
Mar. 28, 2022 (CN) 202210313494.3

(51) Int. Cl. H04W 4/90; H04W 88/04

(52) U.S. Cl. CPC H04W 4/90; H04W 88/04

(57) ABSTRACT

This application discloses a service processing method and apparatus, a terminal, a network side device, and a readable storage medium. The service processing method includes: A first network side device obtains first information, where the first information is used to indicate at least one of the following: a relay on which a relay terminal performs an emergency service, or a relay on which a relay terminal performs an emergency service for a first remote terminal; and sends, based on the first information, second information to a second network side device, where the second information is used to indicate at least one of the following: a relay on which a relay terminal performs an emergency service, or a relay on which a relay terminal performs an emergency service for a first remote terminal.

### CROSS-REFERENCE TO RELATED APPLICATIONS

application is a continuation of International Application No. This PCT/CN2023/084053, filed Mar. 27, 2023, which claims priority to Chinese Patent Application No. 202210313494.3, filed Mar. 28, 2022. The entire contents of each of the above-referenced applications are expressly incorporated herein by reference.

### TECHNICAL FIELD

This application relates to the field of communication technologies, and in particular, to a service processing method and apparatus, a terminal, a network side device, and a readable storage medium.

### BACKGROUND

In conventional technology, for relay communication, data of a remote terminal is transparently transmitted through a core network from a relay terminal to the remote terminal. That is, the relay terminal does not know a type of the data of the remote terminal, including whether the remote terminal is performing transmission of data of an emergency service. In this case, if the remote terminal is performing transmission of a non-emergency service, and the relay terminal supports only an emergency service or a relay on which only an emergency service can be performed in a restricted state, resulting in a waste of emergency service resources.

### SUMMARY

Embodiments of this application provide a service processing method and apparatus, a terminal, a network side device, and a readable storage medium.

According to a first aspect, a service processing method is provided, including the following steps.

A first network side device obtains first information, where the first information is used to indicate at least one of the following: a relay on which a relay terminal performs an emergency service, or a relay on which a relay terminal performs an emergency service for a first remote terminal.

The first network side device sends, based on the first information, second information to a second network side device, where the second information is used to indicate at least one of the following: a relay on which a relay terminal performs an emergency service, or a relay on which a relay terminal performs an emergency service for a first remote terminal.

According to a second aspect, a service processing method is provided, including the following steps.

A second network side device receives second information, where the second information is used to indicate at least one of the following: a relay on which a relay terminal performs an emergency service, or a relay on which a relay terminal performs an emergency service for a first remote terminal.

Based on the second information, the second network side device performs the emergency service of the first remote terminal, and/or refuses a non-emergency service of the first remote terminal.

According to a third aspect, a service processing method is provided, including the following steps.

A terminal obtains first information, where the first information is used to indicate at least one of the following: a relay on which a relay terminal performs an emergency service, or a relay on which a relay terminal performs an emergency service for a first remote terminal.

The terminal sends the first information.

According to a fourth aspect, a service processing apparatus is provided, applied to a first network side device and including:
a first obtaining module, configured to obtain first information, where the first information is used to indicate at least one of the following: a relay on which a relay terminal performs an emergency service, or a relay on which a relay terminal performs an emergency service for a first remote terminal; and
a first sending module, configured to send, based on the first information, second information to a second network side device, where the second information is used to indicate at least one of the following: a relay on which a relay terminal performs an emergency service, or a relay on which a relay terminal performs an emergency service for a first remote terminal.

According to a fifth aspect, a service processing apparatus is provided, applied to a second network side device and including:
a receiving module, configured to receive second information, where the second information is used to indicate at least one of the following: a relay on which a relay terminal performs an emergency service, or a relay on which a relay terminal performs an emergency service for a first remote terminal; and
an execution module, configured to: based on the second information, perform the emergency service of the first remote terminal, and/or refuse a non-emergency service of the first remote terminal.

According to a sixth aspect, a service processing apparatus is provided, applied to a terminal and including:
a second obtaining module, configured to obtain first information, where the first information is used to indicate at least one of the following: a relay on which a relay terminal performs an emergency service, or a relay on which a relay terminal performs an emergency service for a first remote terminal; and
a second sending module, configured to send the first information.

According to a seventh aspect, a terminal is provided. The terminal includes a processor and a memory, the memory stores a program or an instruction that can be run on the processor, and the program or the instruction is executed by the processor to implement the steps of the method according to the third aspect.

According to an eighth aspect, a terminal is provided, including a processor and a communication interface. The communication interface is configured to obtain first information, and send the first information. The first information is used to indicate at least one of the following: a relay on which a relay terminal performs an emergency service, or a relay on which a relay terminal performs an emergency service for a first remote terminal.

According to a ninth aspect, a network side device is provided. The network side device includes a processor and a memory, the memory stores a program or an instruction that can be run on the processor, and the program or the instruction is executed by the processor to implement the steps of the method according to the first aspect or the steps of the method according to the second aspect.

According to a tenth aspect, a network side device is provided, including a processor and a communication interface. When the network side device is a first network side device, the communication interface is configured to: obtain first information, where the first information is used to indicate at least one of the following: a relay on which a relay terminal performs an emergency service, or a relay on which a relay terminal performs an emergency service for a first remote terminal; and send, based on the first information, second information to a second network side device, where the second information is used to indicate at least one of the following: a relay on which a relay terminal performs an emergency service, or a relay on which a relay terminal performs an emergency service for a first remote terminal. In some embodiments, when the network side device is a second network side device, the communication interface is configured to receive second information, where the second information is used to indicate at least one of the following: a relay on which a relay terminal performs an emergency service, or a relay on which a relay terminal performs an emergency service for a first remote terminal; and the processor is configured to: based on the second information, perform the emergency service of the first remote terminal, and/or refuse a non-emergency service of the first remote terminal.

According to an eleventh aspect, a communication system is provided, including a terminal and a network side device. The terminal may be configured to perform the steps of the service processing method according to the third aspect, and the network side device may be configured to perform the steps of the service processing method according to the second aspect or the steps of the service processing method according to the third aspect.

According to a twelfth aspect, a readable storage medium is provided. The readable storage medium stores a program or an instruction, and the program or the instruction is executed by a processor to implement the steps of the method according to the first aspect, the steps of the method according to the second aspect, or the steps of the method according to the third aspect.

According to a thirteenth aspect, a chip is provided. The chip includes a processor and a communication interface, the communication interface is coupled to the processor, and the processor is configured to run a program or an instruction to implement the steps of the method according to the first aspect, the steps of the method according to the second aspect, or the steps of the method according to the third aspect.

According to a fourteenth aspect, a computer program/program product is provided. The computer program/program product is stored in a storage medium, and the computer program/program product is executed by at least one processor to implement the steps of the method according to the first aspect, the steps of the method according to the second aspect, or the steps of the method according to the third aspect.

According to a fifteenth aspect, a communication device is provided, including a processor and a memory, the memory stores a program or an instruction that can be run on the processor, and the program or the instruction is executed by the processor to implement the steps of the method according to the first aspect, the steps of the method according to the second aspect, or the steps of the method according to the third aspect.

In the embodiments of this application, after obtaining first information, a first network side device may send second information to a second network side device, where the first information or the second information is used to indicate at least one of the following: a relay on which a relay terminal performs an emergency service, or a relay on which a relay terminal performs an emergency service for a first remote terminal. Therefore, the second network side device may be caused to: based on the second information, perform the emergency service of the first remote terminal, and/or refuse a non-emergency service of the first remote terminal, so as to ensure that when the relay terminal supports the relay on which the emergency service is performed, only an emergency service of a corresponding remote terminal is performed, and a non-emergency service of the corresponding remote terminal is refused, thereby avoiding a waste of emergency service resources.

### BRIEF DESCRIPTION OF DRAWINGS

FIG. 1 is a block diagram of a wireless communication system to which the embodiments of this application may be applied;

FIG. 2 is a flowchart of a service processing method according to an embodiment of this application;

FIG. 3 is a flowchart of another service processing method according to an embodiment of this application;

FIG. 4 is a flowchart of another service processing method according to an embodiment of this application;

FIG. 5 is a flowchart of a service processing process in an application scenario 1 according to an embodiment of this application;

FIG. 6 is a flowchart of a service processing process in an application scenario 2 according to an embodiment of this application;

FIG. 7 is a flowchart of a service processing process in an application scenario 3 according to an embodiment of this application;

FIG. 8 is a schematic diagram of a structure of a service processing apparatus according to an embodiment of this application;

FIG. 9 is a schematic diagram of a structure of another service processing apparatus according to an embodiment of this application;

FIG. 10 is a schematic diagram of a structure of another service processing apparatus according to an embodiment of this application;

FIG. 11 is a schematic diagram of a structure of a communication device according to an embodiment of this application;

FIG. 12 is a schematic diagram of a structure of a terminal according to an embodiment of this application; and

FIG. 13 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in this specification and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th generation (6G) communication system.

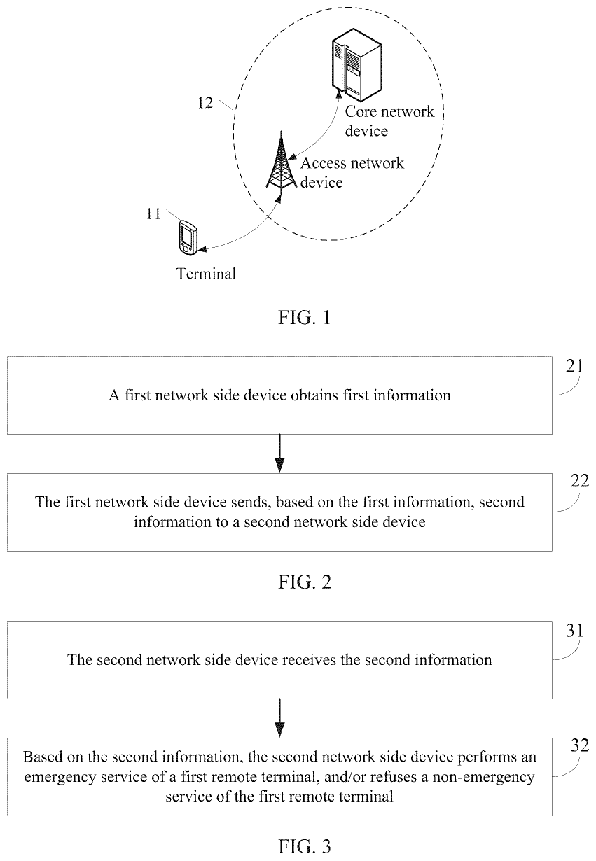

FIG. 1 is a block diagram of a wireless communication system to which the embodiments of this application may be applied. The wireless communication system includes terminals 11 and a network side device 12. The terminal 11 may be a terminal-side device such as a mobile phone, a Tablet Personal Computer (TPC), a Laptop Computer (LC) or a notebook computer, a Personal Digital Assistant (PDA), a palmtop computer, a netbook, an Ultra-mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothing, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access node, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited. The core network device may include but is not limited to at least one of the following: a core network node, a core network function, a Mobility Management Entity (MME), an Access Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), or the like. It should be noted that, in the embodiments of this application, only a core network device in an NR system is used as an example for description, and a specific type of the core network device is not limited.

In some embodiments, scenarios to which the embodiments of this application include but are not limited to layer-2 relay communication, layer-3 relay communication of N3IWF, and the like. For the layer-2 relay communication, both control plane data and user plane data of a remote terminal are transparently transmitted to a layer-2 relay terminal. Therefore, types of data or signaling transmitted by the remote terminal cannot be perceived or learned by the relay terminal. If the layer-2 relay terminal supports only an emergency service (such as announcing a relay set by a security department or a fire alarm), or the layer-2 relay terminal supports a relay on which only an emergency service can be performed in a restricted state (for example, the layer-2 relay terminal is in congestion control, in a non-allowed area, in a prohibited area, or the like, and cannot perform NAS connection, user plane setup, data transmission, or the like), and the remote terminal performs transmission of a non-emergency service at this time. Because the data of the remote terminal is transparently transmitted to the L2 relay terminal, it is actually a deception for the relay terminal and a waste of emergency service resources. Therefore, in relay communication that supports an emergency service, for the layer-2 relay communication, it is necessary to detect whether the data and/or a request of the remote terminal is an emergency service, and to perform only the emergency service and refuse a non-emergency service.

With reference to the accompanying drawings, a service processing method and apparatus, a terminal, a network side device, and a readable storage medium provided in the embodiments of this application are described in detail by using some embodiments and application scenarios thereof.

FIG. 2 is a flowchart of a service processing method according to an embodiment of this application. The method is applied to a first network side device. The first network side device includes but is not limited to a RAN network element, a relay AMF, a relay non-3rd Generation Partnership Project (3rd Generation Partnership Project, 3GPP) interworking function (Non-3GPP InterWorking Function, N3IWF), and the like. The relay AMF and the relay N3IWF are network functions corresponding to a relay terminal. As shown in FIG. 2, the method includes the following steps.

Step 21: The first network side device obtains first information.

In this embodiment, the first information is used to indicate at least one of the following: a relay on which a relay terminal performs an emergency service, or a relay on which a relay terminal performs an emergency service for a first remote terminal. To be specific, the first information may be understood as transmission rule information, and indicates that the relay terminal supports the relay of the emergency service. The relay terminal may be a terminal that is performing a relay operation, or may be a terminal that is to perform a relay operation. This is not limited herein. The first remote terminal is a remote terminal served by the relay terminal, and the relay terminal supports providing a relay service for the emergency service of the first remote terminal.

In some embodiments, the first information may include but is not limited to at least one of the following: an identifier of the relay terminal or an identifier of the first remote terminal. In this way, the relay on which the relay terminal corresponding to the identifier performs the emergency service may be indicated by using the identifier of the relay terminal in the first information. In some embodiments, the relay on which the relay terminal corresponding to the identifier performs the emergency service for the first remote terminal by using the identifier of the relay terminal and the identifier of the first remote terminal in the first information. In some embodiments, the relay on which a corresponding relay terminal performs the emergency service for the first remote terminal may be indicated by using the identifier of the first remote terminal in the first information.

In some embodiments, if the relay terminal is performing the relay of the emergency service, the first information may indicate at least one of the following: the relay on which the relay terminal is performing the emergency service, or the relay on which the relay terminal is performing the emergency service for the first remote terminal.

In some embodiments, if the first network side device is the RAN network element, the first network side device may receive the first information from the relay AMF, the relay terminal, or the like.

In some other embodiments, if the first network side device is the relay AMF, the first network side device may receive the first information from the relay terminal or the like.

In some other embodiments, if the first network side device is the relay N3IWF, the first network side device may receive the first information from a relay UPF or the like. Further, the relay UPF may receive the first information from the relay terminal or the RAN network element.

Step 22: The first network side device sends, based on the first information, second information to a second network side device.

In this embodiment, the second information is used to indicate at least one of the following: a relay on which a relay terminal performs an emergency service, or a relay on which a relay terminal performs an emergency service for a first remote terminal. To be specific, the second information may be understood as transmission rule information, and indicates that the relay terminal supports the relay of the emergency service. Then, if the relay terminal transparently transmits data or signaling of the first remote terminal, the second network side device may determine, based on the second information and a type indication of the data or the signaling, whether to accept the data or the signaling, and perform only the emergency service and refuse a non-emergency service.

In some embodiments, the second network side device may be a remote AMF, a remote SMF, or a remote UPF, that is, a core network function AMF, SMF or UPF corresponding to the remote terminal, so as to perform or refuse an emergency service of a corresponding remote terminal.

In some embodiments, the second information may include but is not limited to at least one of the following: an identifier of the relay terminal or an identifier of the first remote terminal. In this way, the relay on which the relay terminal corresponding to the identifier performs the emergency service may be indicated by using the identifier of the relay terminal in the second information. In some embodiments, the relay on which the relay terminal corresponding to the identifier performs the emergency service for the first remote terminal may be indicated by using the identifier of the relay terminal and the identifier of the first remote terminal in the second information. In some embodiments, the relay on which a corresponding relay terminal performs the emergency service for the first remote terminal may be indicated by using the identifier of the first remote terminal in the second information.

In some embodiments, if the relay terminal is performing the relay of the emergency service, the second information may indicate at least one of the following: the relay on which the relay terminal is performing the emergency service, or the relay on which the relay terminal is performing the emergency service for the first remote terminal.

According to the service processing method in this embodiment of this application, after obtaining the first information, the first network side device may send the second information to the second network side device, where the first information or the second information is used to indicate at least one of the following: the relay on which the relay terminal performs the emergency service, or the relay on which the relay terminal performs the emergency service for the first remote terminal. Therefore, the second network side device may be caused to: based on the second information, perform the emergency service of the first remote terminal, and/or refuse a non-emergency service of the first remote terminal, so as to ensure that when the relay terminal supports the relay on which the emergency service is performed, only an emergency service of a corresponding remote terminal is performed, and a non-emergency service of the corresponding remote terminal is refused, thereby avoiding a waste of emergency service resources.

It should be noted that in this embodiment of this application, the first information may be the same as or different from the second information. That is, in some cases, the first information may be the same as the second information, where the first network side device plays a role of forwarding indication information. In some other cases, the first information is different from the second information, where the first network side device generates, based on the obtained first information, the second information and sends the second information to the second network side device.

In some embodiments, the first information is used to indicate a relay on which a relay terminal performs an emergency service, and the second information is used to indicate a relay on which a relay terminal performs an emergency service for a first remote terminal. In this case, the first information may include the identifier of the relay terminal, and the second information may include the identifier of the relay terminal and the identifier of the first remote terminal. For example, after obtaining the first information that indicates the relay on which the relay terminal performs the emergency service, the first network side device (for example, the RAN network element) determines that the relay terminal supports providing the relay service for the first remote terminal, then the first network side device may generate the second information that indicates the relay on which the relay terminal performs the emergency service for the first remote terminal, and send the second information to the second network side device.

In some embodiments, the first information is used to indicate a relay on which a relay terminal performs an emergency service, and the second information is used to indicate a relay on which a relay terminal performs an emergency service. In this case, content indicated by the first information is the same as that indicated by the second information, and the first network side device plays a role of forwarding indication information.

In some embodiments, the first information is used to indicate a relay on which a relay terminal performs an emergency service for a first remote terminal, and the second information is used to indicate a relay on which a relay terminal performs an emergency service for a first remote terminal. In this case, content indicated by the first information is the same as that indicated by the second information, and the first network side device plays a role of forwarding indication information.

In some embodiments, obtaining the first information may include: The first network side device obtains the first information in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; or
a Packet Data Unit (PDU) session request type of the relay terminal is an emergency type.

In this way, according to the foregoing case, the relay on which the relay terminal performs the emergency service may be determined, and/or the relay on which the relay terminal performs the emergency service for the first remote terminal may be determined, so as to accurately obtain the first information.

In some embodiments, receiving the first information may include: The first network side device receives the first information from a third network side device and/or the relay terminal. For example, when the first network side device is the RAN network element, the third network side device is the relay AMF. For another example, when the first network side device is the relay N3IWF, the third network side device is the relay UPF.

In some embodiments, the first information may be sent by the third network side device in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
data and/or signaling of the first remote terminal is detected;
a registration type of the relay terminal is an emergency type;
a service request type of the relay terminal is an emergency type; or
a PDU session request type of the relay terminal is an emergency type.

In some embodiments, sending the second information to the second network side device may include: The first network side device sends the second information to the second network side device in a case that the data and/or the signaling of the first remote terminal is received. That is, in a case that it is necessary to determine whether to accept the data and/or the signaling of the first remote terminal, the second information is sent to the second network side device. This signaling may be request signaling, such as a Radio Resource Control (RRC) connection setup request or an RRC connection modification request.

FIG. 3 is a flowchart of a service processing method according to an embodiment of this application. The method is applied to a second network side device, and the second network side device includes but is not limited to a remote AMF, a remote SMF, a remote PCF, and the like, which are core network functions corresponding to a remote terminal. As shown in FIG. 3, the method includes the following steps.

Step 31: The second network side device receives second information.

In this embodiment, the second information is used to indicate at least one of the following: a relay on which a relay terminal performs an emergency service, or a relay on which a relay terminal performs an emergency service for a first remote terminal. To be specific, the second information may be understood as transmission rule information, and indicates that the relay terminal supports the relay of the emergency service. The relay terminal may be a terminal that is performing a relay operation, or may be a terminal that is to perform a relay operation. This is not limited herein. The first remote terminal is a remote terminal served by the relay terminal, and the relay terminal supports providing a relay service for the emergency service of the first remote terminal.

In some embodiments, the second information may include but is not limited to at least one of the following: an identifier of the relay terminal or an identifier of the first remote terminal. In this way, the relay on which the relay terminal corresponding to the identifier performs the emergency service may be indicated by using the identifier of the relay terminal in the second information. In some embodiments, the relay on which the relay terminal corresponding to the identifier performs the emergency service for the first remote terminal may be indicated by using the identifier of the relay terminal and the identifier of the first remote terminal in the second information. In some embodiments, the relay on which a corresponding relay terminal performs the emergency service for the first remote terminal may be indicated by using the identifier of the first remote terminal in the second information.

In some embodiments, if the relay terminal is performing the relay of the emergency service, the second information may indicate at least one of the following: the relay on which the relay terminal is performing the emergency service, or the relay on which the relay terminal is performing the emergency service for the first remote terminal.

In some embodiments, if the second network side device is the remote AMF or the remote SMF, the second network side device may receive the second information from the first network side device (such as the RAN network element, the relay AMF, the relay N3IWF, or the like).

Step 33: Based on the second information, the second network side device performs the emergency service of the first remote terminal, and/or refuses a non-emergency service of the first remote terminal.

In some embodiments, before step 33, the second network side device may receive data and/or a request message sent by the first remote terminal, so as to perform the emergency service, or refuse the non-emergency service of the first remote terminal.

According to the service processing method in this embodiment of this application, based on the received second information, the second network side device may perform the emergency service of the first remote terminal, and/or refuse the non-emergency service of the first remote terminal. The second information is used to indicate at least one of the following: the relay on which the relay terminal performs the emergency service, or the relay on which the relay terminal performs the emergency service for the first remote terminal. Therefore, it is ensured that when the relay terminal supports the relay on which the emergency service is performed, only an emergency service of a corresponding remote terminal is performed, and a non-emergency service of the corresponding remote terminal is refused, thereby avoiding a waste of emergency service resources.

In this embodiment of this application, step 33 may include at least one of the following:

The second network side device sends, based on the second information, the data of the first remote terminal in a case that it is determined that a type of the data of the first remote terminal is an emergency type; or refuses to send, based on the second information, the data of the first remote terminal in a case that it is determined that a type of the data of the first remote terminal is not an emergency type.

The second network side device responds, based on the second information, to the request message of the first remote terminal in a case that it is determined that a type of the request message of the first remote terminal is an emergency type; or refuses, based on the second information, the request message of the first remote terminal in a case that it is determined that a type of the request message of the first remote terminal is not an emergency type. For example, the request message is an RRC connection setup request or an RRC connection modification request.

In some embodiments, the second network side device may determine, based on a type indication in the data of the first remote terminal, the type of the data of the first remote terminal is or is not an emergency type. The type indication is used to indicate that the type of the corresponding data is or is not an emergency type.

In some embodiments, the second network side device may determine, based on a type indication in the request message of the first remote terminal, the type of the request message of the first remote terminal is or is not an emergency type. The type indication is used to indicate that the type of the corresponding request message is or is not an emergency type.

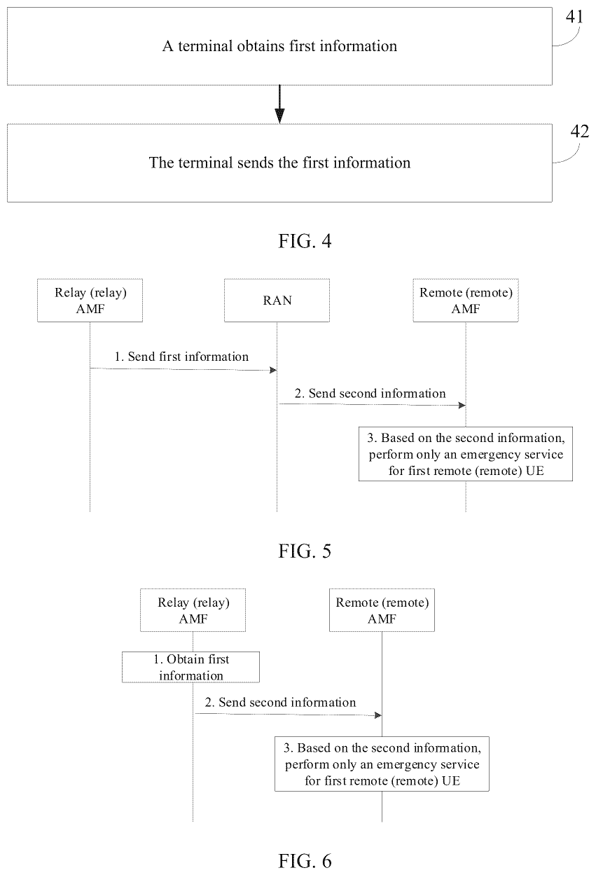

FIG. 4 is a flowchart of a service processing method according to an embodiment of this application. The method is applied to a terminal. The terminal may be a relay terminal, or another terminal associated with a relay terminal (for example, a terminal that may forward transmission information of the relay terminal). As shown in FIG. 4, the method includes the following steps.

Step 41: The terminal obtains first information.

In this embodiment, the first information is used to indicate at least one of the following: a relay on which a relay terminal performs an emergency service, or a relay on which a relay terminal performs an emergency service for a first remote terminal. To be specific, the first information may be understood as transmission rule information, and indicates that the relay terminal supports the relay of the emergency service. The relay terminal may be a terminal that is performing a relay operation, or may be a terminal that is to perform a relay operation. This is not limited herein. The first remote terminal is a remote terminal served by the relay terminal, and the relay terminal supports providing a relay service for the emergency service of the first remote terminal.

In some embodiments, the first information may include but is not limited to at least one of the following: an identifier of the relay terminal or an identifier of the first remote terminal. In this way, the relay on which the relay terminal corresponding to the identifier performs the emergency service may be indicated by using the identifier of the relay terminal in the first information. In some embodiments, the relay on which the relay terminal corresponding to the identifier performs the emergency service for the first remote terminal by using the identifier of the relay terminal and the identifier of the first remote terminal in the first information. In some embodiments, the relay on which a corresponding relay terminal performs the emergency service for the first remote terminal may be indicated by using the identifier of the first remote terminal in the first information.

In some embodiments, if the relay terminal is performing the relay of the emergency service, the first information may indicate at least one of the following: the relay on which the relay terminal is performing the emergency service, or the relay on which the relay terminal is performing the emergency service for the first remote terminal.

Step 42: The terminal sends the first information.

In some embodiments, the relay terminal may perform sending to a RAN network element and/or a relay AMF.

According to the service processing method in this embodiment of this application, the terminal sends the first information, so that after obtaining the first information, the first network side device sends the second information to the second network side device, where the first information or the second information is used to indicate at least one of the following: the relay on which the relay terminal performs the emergency service, or the relay on which the relay terminal performs the emergency service for the first remote terminal. Therefore, based on the received second information, the second network side device may be caused to perform the emergency service of the first remote terminal, and/or refuse a non-emergency service of the first remote terminal, so as to ensure that when the relay terminal supports the relay on which the emergency service is performed, only an emergency service of a corresponding remote terminal is performed, and a non-emergency service of the corresponding remote terminal is refused, thereby avoiding a waste of emergency service resources.

In some embodiments, obtaining the first information may include: The terminal obtains the first information in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; or
a PDU session request type of the relay terminal is an emergency type.

In this way, according to the foregoing case, the relay on which the relay terminal performs the emergency service may be determined, and/or the relay on which the relay terminal performs the emergency service for the first remote terminal may be determined, so as to accurately obtain the first information.

In some embodiments, after a relay path of the emergency service is established, the relay terminal forwards data and/or a request message to the first remote terminal, where the data and/or the request message includes a type indication, and the type indication is used to indicate whether a service type of the data and/or the request message is an emergency type. Then, if a core network element corresponding to the first remote terminal receives the data and/or the request message, based on the received second information and the type indication in the data and/or the request message, only the emergency service may be executed and the non-emergency service may be refused.

This application is described below with reference to specific embodiments.

### Embodiment 1

In Embodiment 1, it is mainly described that in layer-2 relay communication, a RAN network element obtains first information, and sends second information to a remote AMF, so that the remote AMF determines whether to perform a service for remote UE. As shown in FIG. 5, the method includes the following steps.

Step 1: The relay AMF determines that relay UE performs a relay of an emergency service, obtains and sends the first information to the RAN network element, where the first information may be as described in the foregoing embodiments, and details are not described herein again.

In this step, the relay AMF may determine the relay on which the relay UE performs the emergency service in a case that at least one piece of the following information is learned: a relay service code of a service performed by the relay UE is associated with an emergency type, a service type performed by the relay UE is an emergency type, the relay UE receives a relay indication of an emergency service of a remote terminal, the relay UE performs a relay indication of an emergency service, a registration type of the relay UE is an emergency type, and the like.

Step 2: After receiving the first information, the RAN network element sends the second information to the remote AMF, where the second information may be as described in the foregoing embodiments, and details are not described herein again.

In an implementation, after receiving a request message (such as an RRC connection setup request) from a first remote terminal, the RAN network element sends the second information to the remote AMF.

Step 3: Based on the received second information and with reference to a type indication in data and/or a request message of first remote UE, the remote AMF performs only the emergency service for the first remote UE and refuses a non-emergency service.

### Embodiment 2

In Embodiment 2, it is mainly described that in layer-2 relay communication, a relay AMF obtains first information, and sends second information to a remote AMF, so that the remote AMF determines whether to perform a service for remote UE. As shown in FIG. 6, the method includes the following steps:

Step 1: The relay AMF determines that relay UE performs a relay of an emergency service, obtains the first information and sends the second information to the remote AMF, where the first information and the second information may be as described in the foregoing embodiments, and details are not described herein again.

Step 2 and step 3: Based on the received second information and with reference to a type indication in data and/or a request message of first remote UE, the remote AMF performs only the emergency service for the first remote UE and refuses a non-emergency service.

### Embodiment 3

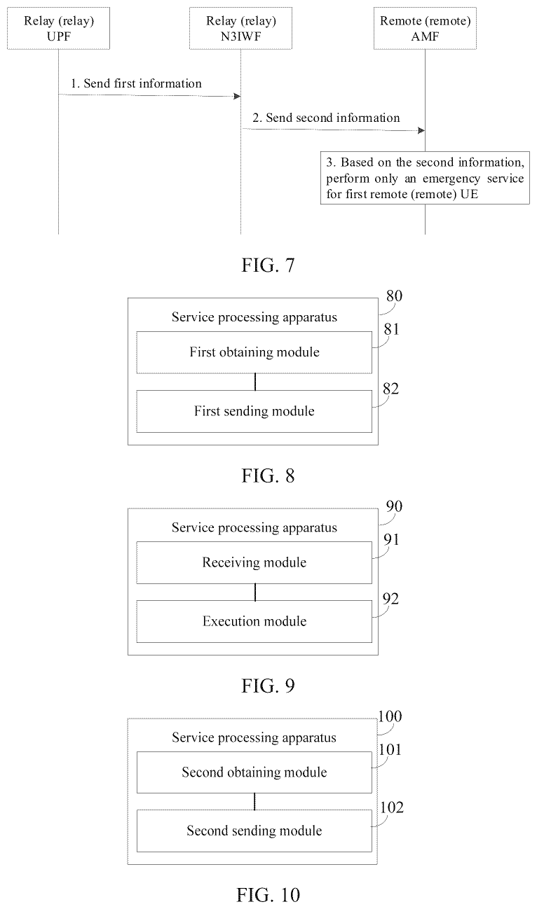

In Embodiment 3, it is mainly described that in layer-3 relay communication of N3IWF, a relay UPF obtains and sends first information to a relay N3IWF, and the relay N3IWF sends second information to a remote AMF, so that the remote AMF determines whether to perform a service for remote UE. As shown in FIG. 7, the method includes the following steps:

Step 1: Based on the following cases in which a relay service code of a service performed by relay UE is associated with an emergency type, a service type performed by the relay UE is an emergency type, the relay UE receives a relay indication of an emergency service of a remote terminal, the relay UE performs a relay indication of an emergency service, a registration type of the relay UE is an emergency type, and the like, the relay UPF determines the relay on which the relay UE performs the emergency service, and obtains and sends the first information to the relay N3IWF, where the first information may be as described in the foregoing embodiments, and details are not described herein again.

In an implementation, when detecting data or signaling of first remote UE, the relay UPF sends the first information to the relay N3IWF.

Step 2: After receiving the first information, the relay N3IWF sends the second information to the remote AMF, where the second information may be as described in the foregoing embodiments, and details are not described herein again.

Step 3: Based on the received second information and with reference to a type indication in data and/or a request message of first remote UE, the remote AMF performs only the emergency service for the first remote UE and refuses a non-emergency service.

The service processing method provided in the embodiments of this application may be performed by a service processing apparatus. In this embodiment of this application, an example in which the service processing apparatus performs the service processing method is used to describe the service processing apparatus provided in this embodiment of this application.

FIG. 8 is a schematic diagram of a structure of a service processing apparatus according to an embodiment of this application. The apparatus is applied to a first network side device, and the first network side device includes but is not limited to a RAN network element, a relay AMF, a relay N3IWF and the like. As shown in FIG. 8, a service processing apparatus 80 includes:
a first obtaining module 81, configured to obtain first information, where the first information is used to indicate at least one of the following: a relay on which a relay terminal performs an emergency service, or a relay on which a relay terminal performs an emergency service for a first remote terminal; and
a first sending module 82, configured to send, based on the first information, second information to a second network side device, where the second information is used to indicate at least one of the following: a relay on which a relay terminal performs an emergency service, and a relay on which a relay terminal performs an emergency service for a first remote terminal.

In some embodiments, the first information is used to indicate a relay on which a relay terminal performs an emergency service, and the second information is used to indicate a relay on which a relay terminal performs an emergency service for a first remote terminal.

In some embodiments, the first information is used to indicate a relay on which a relay terminal performs an emergency service, and the second information is used to indicate a relay on which a relay terminal performs an emergency service.

In some embodiments, the first information is used to indicate a relay on which a relay terminal performs an emergency service for a first remote terminal, and the second information is used to indicate a relay on which a relay terminal performs an emergency service for a first remote terminal.

In some embodiments, the first information may include at least one of the following: an identifier of the relay terminal and an identifier of the first remote terminal; and/or the second information may include at least one of the following: the identifier of the relay terminal and the identifier of the first remote terminal.

In some embodiments, the first obtaining module 81 is configured to obtain the first information in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; and
a PDU session request type of the relay terminal is an emergency type.

In some embodiments, the first obtaining module 81 is configured to:
receive the first information from a third network side device and/or a relay terminal.

In some embodiments, the first information is sent by the third network side device in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
data and/or signaling of the first remote terminal is detected;
a registration type of the relay terminal is an emergency type;
a service request type of the relay terminal is an emergency type; and
a PDU session request type of the relay terminal is an emergency type.

In some embodiments, the first sending module 82 is configured to send the second information to the second network side device in a case that the data and/or the signaling of the first remote terminal is received.

The service processing apparatus 80 according to this embodiment of this application can implement the processes in the method embodiment of FIG. 2, and achieve the same technical effect. To avoid repetition, details are not described herein again.

FIG. 9 is a schematic diagram of a structure of another service processing apparatus according to an embodiment of this application. The apparatus is applied to a second network side device, and the second network side device includes but is not limited to a remote AMF, a remote SMF, a remote PCF, and the like. As shown in FIG. 9, a service processing apparatus 90 includes:

a receiving module 91, configured to receive second information, where the second information is used to indicate at least one of the following: a relay on which a relay terminal performs an emergency service, and a relay on which a relay terminal performs an emergency service for a first remote terminal; and an execution module 92, configured to perform, based on the second information, the emergency service of the first remote terminal, and/or refuse a non-emergency service of the first remote terminal.

In some embodiments, the second information includes at least one of the following: an identifier of the relay terminal and an identifier of the first remote terminal.

In some embodiments, the receiving module 91 is further configured to receive data and/or a request message sent by the first remote terminal.

In some embodiments, the execution module 92 is configured to perform at least one of the following:
send, based on the second information, the data of the first remote terminal in a case that it is determined that a type of the data of the first remote terminal is an emergency type; or refuse to send, based on the second information, the data of the first remote terminal in a case that it is determined that a type of the data of the first remote terminal is not an emergency type; and
respond, based on the second information, to the request message of the first remote terminal in a case that it is determined that a type of the request message of the first remote terminal is an emergency type; or refuse, based on the second information, the request message of the first remote terminal in a case that it is determined that a type of the request message of the first remote terminal is not an emergency type.

In some embodiments, the execution module 92 is further configured to perform at least one of following:
determine, based on a type indication in the data of the first remote terminal, the type of the data of the first remote terminal is or is not an emergency type; and
determine, based on a type indication in the request message of the first remote terminal, the type of the request message of the first remote terminal is or is not an emergency type.

The service processing apparatus 90 according to this embodiment of this application can implement the processes in the method embodiment of FIG. 3, and achieve the same technical effect. To avoid repetition, details are not described herein again.

FIG. 10 is a schematic diagram of a structure of a service processing apparatus according to an embodiment of this application. The apparatus is applied to a terminal. As shown in FIG. 10, a service processing apparatus 100 includes:

a second obtaining module 101, configured to obtain first information, where the first information is used to indicate at least one of the following: a relay on which a relay terminal performs an emergency service, and a relay on which a relay terminal performs an emergency service for a first remote terminal; and a second sending module 102, configured to send the first information.

In some embodiments, the first information includes at least one of the following: an identifier of the relay terminal and an identifier of the first remote terminal.

In some embodiments, the second obtaining module 101 is configured to obtain the first information in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; and
a PDU session request type of the relay terminal is an emergency type.

In some embodiments, when the terminal is the relay terminal, the second sending module 102 is further configured to: after a relay path of the emergency service is established, forward data and/or a request message to the first remote terminal, where the data and/or the request message includes a type indication, and the type indication is used to indicate whether a service type of the data and/or the request message is an emergency type.

The service processing apparatus 100 according to this embodiment of this application can implement the processes in the method embodiment of FIG. 4, and achieve the same technical effect. To avoid repetition, details are not described herein again.

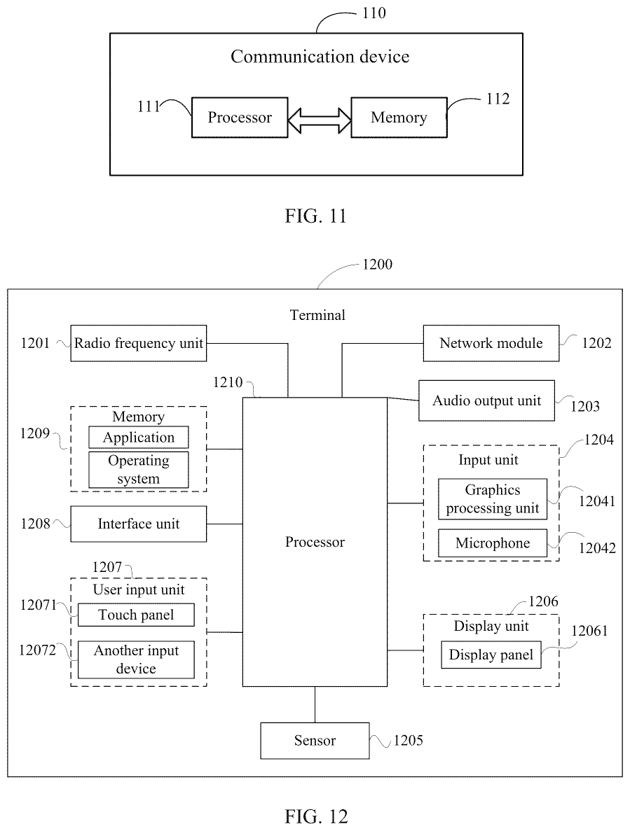

As shown in FIG. 11, an embodiment of this application further provides a communication device 110, including a processor 111 and a memory 112. The memory 112 stores a program or an instruction that can be run on the processor 111. For example, when the communication device 110 is a first network side device, the program or the instruction is executed by the processor 111 to implement the steps of the service processing method embodiment shown in FIG. 2, and a same technical effect can be achieved. When the communication device 110 is a second network side device, the program or the instruction is executed by the processor 111 to implement the steps of the service processing method embodiment shown in FIG. 3, and a same technical effect can be achieved. When the communication device 110 is a terminal, the program or the instruction is executed by the processor 111 to implement the steps of the service processing method embodiment shown in FIG. 4, and a same technical effect can be achieved. To avoid repetition, details are not described herein again.

An embodiment of this application further provides a terminal, including a processor and a communication interface. The communication interface is configured to obtain first information, and send the first information. The first information is used to indicate at least one of the following: a relay on which a relay terminal performs an emergency service, and a relay on which a relay terminal performs an emergency service for a first remote terminal. The terminal embodiment is corresponding to the terminal side method embodiment, the implementation processes and implementations of the method embodiment can be applied to the terminal embodiment, and a same technical effect can be achieved.

FIG. 12 is a schematic diagram of a hardware structure of a terminal according to an embodiment of this application.

A terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that in this embodiment of this application, the input unit 1204 may include a Graphics Processing Unit (GPU) 12041 and a microphone 12042. The graphics processing unit 12041 processes image data of a static picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, the radio frequency unit 1201 receives downlink data from a network side device and then sends the downlink data to the processor 1210 for processing; and the radio frequency unit 1201 may send uplink data to the network side device. Usually, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may be a volatile memory or a non-volatile memory, or the memory 1209 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 1209 in this embodiment of this application includes but is not limited to these memories and any memory of another proper type.

The processor 1210 may include one or more processing units. In some embodiments, an application processor and a modem processor are integrated into the processor 1210. The application processor mainly processes an operating system, a user interface, an application, or the like. The modem processor mainly processes a wireless communication signal, for example, a baseband processor. It may be understood that, the modem processor may not be integrated into the processor 1210.

The radio frequency unit 1201 is configured to obtain first information and sends the first information, where the first information is used to indicate at least one of the following: a relay on which a relay terminal performs an emergency service, and a relay on which a relay terminal performs an emergency service for a first remote terminal.

In some embodiments, the first information includes but is not limited to at least one of the following: an identifier of the relay terminal and an identifier of the first remote terminal.

In some embodiments, the radio frequency unit 1201 is further configured to obtain the first information in a case that at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; and
a PDU session request type of the relay terminal is an emergency type.

In some embodiments, when the terminal 1200 is the relay terminal, the processor 1210 is configured to: after a relay path of the emergency service is established, forward data and/or a request message to the first remote terminal, where the data and/or the request message includes a type indication, and the type indication is used to indicate whether a service type of the data and/or the request message is an emergency type.

The terminal 1200 provided in this embodiment of this application can implement the processes implemented in the method embodiment in FIG. 4, and achieve a same technical effect. To avoid repetition, details are not described herein again.

An embodiment of this application further provides a network side device, including a processor and a communication interface. When the network side device is a first network side device, the communication interface is configured to: obtain first information, where the first information is used to indicate at least one of the following: a relay on which a relay terminal performs an emergency service, and a relay on which a relay terminal performs an emergency service for a first remote terminal; and send, based on the first information, second information to a second network side device, where the second information is used to indicate at least one of the following: a relay on which a relay terminal performs an emergency service, and a relay on which a relay terminal performs an emergency service for a first remote terminal. In some embodiments, when the network side device is a second network side device, the communication interface is configured to: receive second information, where the second information is used to indicate at least one of the following: a relay on which a relay terminal performs an emergency service, and a relay on which a relay terminal performs an emergency service for a first remote terminal; and the processor is configured to: based on the second information, perform the emergency service of the first remote terminal, and/or refuse a non-emergency service of the first remote terminal. The network side device embodiment is corresponding to the foregoing method embodiment of the network side device. The implementation processes and implementations of the foregoing method embodiment may be applicable to the network side device embodiment, and a same technical effect can be achieved. Details are not described herein again.

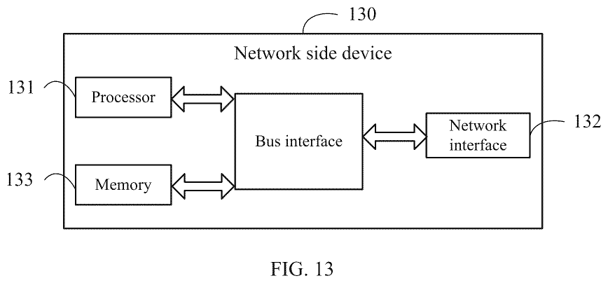

An embodiment of this application further provides a network side device. As shown in FIG. 13, a network side device 130 includes: a processor 131, network interface 132 and a memory 133. The network interface 132 is, for example, a common public radio interface (CPRI).

The network side device 130 in this embodiment of this application further includes an instruction or a program that is stored in the memory 133 and that can be run on the processor 131. The processor 131 invokes the instruction or the program in the memory 133 to execute the method performed by the modules shown in FIG. 8 or FIG. 9, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing service processing method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing service processing method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing service processing method embodiment, and a same technical effect can be achieved. To avoid repetition, details are not described herein again.

An embodiment of this application further provides a communication system, including a terminal and a network side device. The terminal may be configured to perform the steps of the method shown in FIG. 4, and the network side device may be configured to perform the steps of the method shown in FIG. 2 or the steps of the method shown in FIG. 3.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for service processing, comprising:
obtaining, by a first network side device, first information, wherein the first information is used to indicate at least one of the following: a relay on which a relay terminal performs an emergency service, or a relay on which a relay terminal performs an emergency service for a first remote terminal; and
sending, by the first network side device based on the first information, second information to a second network side device, wherein the second information is used to indicate at least one of the following: a relay on which a relay terminal performs an emergency service, or a relay on which a relay terminal performs an emergency service for a first remote terminal.

2. The method according to claim 1, wherein the first information is used to indicate a relay on which a relay terminal performs an emergency service, and the second information is used to indicate a relay on which a relay terminal performs an emergency service for a first remote terminal; or
the first information is used to indicate a relay on which a relay terminal performs an emergency service, and the second information is used to indicate a relay on which a relay terminal performs an emergency service; or
the first information is used to indicate a relay on which a relay terminal performs an emergency service for a first remote terminal, and the second information is used to indicate a relay on which a relay terminal performs an emergency service for a first remote terminal.

3. The method according to claim 1, wherein:
the first information comprises at least one of the following:
an identifier of the relay terminal or an identifier of the first remote terminal; or
the second information comprises at least one of the following:
an identifier of the relay terminal or an identifier of the first remote terminal.

4. The method according to claim 1, wherein the obtaining first information comprises:
obtaining, by the first network side device, the first information when at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; or
a Packet Data Unit (PDU) session request type of the relay terminal is an emergency type.

5. The method according to claim 1, wherein the obtaining first information comprises:
receiving, by the first network side device, the first information from a third network side device or a relay terminal.

6. The method according to claim 5, wherein the first information is sent by the third network side device when at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
data or signaling of the first remote terminal is detected;
a registration type of the relay terminal is an emergency type;
a service request type of the relay terminal is an emergency type; or
a Packet Data Unit (PDU) session request type of the relay terminal is an emergency type.

7. The method according to claim 1, wherein the sending second information to a second network side device comprises:
sending, by the first network side device, the second information to the second network side device when the data or the signaling of the first remote terminal is received.

8. A method for service processing, comprising:
receiving, by a second network side device, second information, wherein the second information is used to indicate at least one of the following: a relay on which a relay terminal performs an emergency service, or a relay on which a relay terminal performs an emergency service for a first remote terminal; and
performing, by the second network side device based on the second information, the emergency service of the first remote terminal, or refusing a non-emergency service of the first remote terminal.

9. The method according to claim 8, wherein the second information comprises at least one of the following:
an identifier of the relay terminal or an identifier of the first remote terminal.

10. The method according to claim 8, wherein before the performing, by the second network side device based on the second information, the emergency service of the first remote terminal, or refusing a non-emergency service of the first remote terminal, the method further comprises:
receiving, by the second network side device, data or a request message sent by the first remote terminal.

11. The method according to claim 8, wherein the performing, based on the second information, the emergency service of the first remote terminal, or refusing a non-emergency service of the first remote terminal comprises at least one of the following:
sending, by the second network side device based on the second information, the data of the first remote terminal when it is determined that a type of the data of the first remote terminal is an emergency type; or refusing to send, by the second network side device based on the second information, the data of the first remote terminal when it is determined that a type of the data of the first remote terminal is not an emergency type; or
responding, by the second network side device based on the second information, to the request message of the first remote terminal when it is determined that a type of the request message of the first remote terminal is an emergency type; or refusing, by the second network side device based on the second information, the request message of the first remote terminal when it is determined that a type of the request message of the first remote terminal is not an emergency type.

12. The method according to claim 11, further comprising at least one of the following:
determining, by the second network side device based on a type indication in the data of the first remote terminal, the type of the data of the first remote terminal is or is not an emergency type; or
determining, by the second network side device based on a type indication in the request message of the first remote terminal, the type of the request message of the first remote terminal is or is not an emergency type.

13. A method for service processing, comprising:
obtaining, by a terminal, first information, wherein the first information is used to indicate at least one of the following: a relay on which a relay terminal performs an emergency service, or a relay on which a relay terminal performs an emergency service for a first remote terminal; and
sending, by the terminal, the first information.

14. The method according to claim 13, wherein the first information comprises at least one of the following:
an identifier of the relay terminal or an identifier of the first remote terminal.

15. The method according to claim 13, wherein the obtaining first information comprises:
obtaining, by the terminal, the first information when at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; or
a Packet Data Unit (PDU) session request type of the relay terminal is an emergency type.

16. The method according to claim 13, wherein the terminal is the relay terminal, and the method further comprises:
after a relay path of the emergency service is established, the relay terminal forwards data or a request message to the first remote terminal, wherein the data or the request message comprises a type indication, and the type indication is used to indicate whether a service type of the data or the request message is an emergency type.

17. A terminal, comprising: a memory storing a computer program; and a processor coupled to the memory and configured to execute the computer program to perform the method for service processing according to claim 13.

18. The terminal according to claim 17, wherein the first information comprises at least one of the following:
an identifier of the relay terminal or an identifier of the first remote terminal.

19. The terminal according to claim 17, wherein the obtaining first information comprises:
obtaining, by the terminal, the first information when at least one of the following is satisfied:
a relay service code of a service performed by the relay terminal is associated with an emergency type;
a service type performed by the relay terminal is an emergency type;
the relay terminal receives a relay indication of an emergency service from a remote terminal;
the relay terminal performs a relay indication of an emergency service;
the relay terminal performs a relay indication of an emergency service for the first remote terminal;
a registration type of the relay terminal is an emergency type;
a service request type of the relay terminal is an emergency type; or
a Packet Data Unit (PDU) session request type of the relay terminal is an emergency type.

20. The terminal according to claim 17, wherein the terminal is the relay terminal, and performing the method for service processing further comprises:
after a relay path of the emergency service is established, the relay terminal forwards data or a request message to the first remote terminal, wherein the data or the request message comprises a type indication, and the type indication is used to indicate whether a service type of the data or the request message is an emergency type.
